(19) United States
(12) Patent Application Publication
(10) Pub. No.: US 2016/0057597 A1
(43) Pub. Date: Feb. 25, 2016

(54) AUDIO EMERGENCY BEACON

(71) Applicant: GORDON HINES, KIRKLAND, WA (US)

(72) Inventor: GORDON HINES, KIRKLAND, WA (US)

(73) Assignee: TELECOMMUNICATION SYSTEMS, INC., ANNAPOLIS, MD (US)

(21) Appl. No.: 14/526,921

(22) Filed: Oct. 29, 2014

Related U.S. Application Data
(60) Provisional application No. 62/041,475, filed on Aug. 25, 2014.

(51) Int. Cl. H04W 4/22; H04W 4/02

(52) U.S. Cl. CPC H04W 4/22; H04W 4/02

(57) ABSTRACT

One example includes a method for initiating an audio emergency beacon. The method includes facilitating receipt of inputs on a wireless electronic device that correspond to a request for emergency services. The method also includes emitting the audio emergency beacon via an acoustic output device of the wireless electronic device in response to the inputs. The audio emergency beacon can have an audio frequency that is outside of a typical perceptible frequency range of human hearing.

### RELATED APPLICATIONS

This application claims priority from U.S. Patent Application Ser. No. 62/041,475, filed 25 Aug. 2014, which is incorporated herein in its entirety.

### TECHNICAL FIELD

This disclosure relates to an audio emergency beacon.

### BACKGROUND

Emergency services allow a user of a telephone, be it a land-line or a mobile phone, to contact a Public Safety Answering Point (PSAP) to request help. The PSAP can then contact the appropriate authorities, such as to contact the fire department in the event of a fire, to contact the police to prevent or after occurrence of a crime, or to contact a hospital or medical dispatch service in the event of a medical emergency. Therefore, the PSAP acts quickly to provide help to the calling party. In some cases, it may be difficult to obtain help for the calling party in a sufficiently rapid manner, such that the calling party may be in peril before the appropriate authorities can arrive at the scene designated by the PSAP. For example, a person having a medical emergency may become unconscious and/or unresponsive before an ambulance arrives, or a person could wish to remain silent in the presence of potential danger. In such circumstances, emergency response providers may have to search for the caller.

### SUMMARY

One example includes a method for initiating an audio emergency beacon. The method includes facilitating receipt of inputs on a wireless electronic device that correspond to a request for emergency services. The method also includes emitting the audio emergency beacon via an acoustic output device of the wireless electronic device in response to the inputs. The audio emergency beacon can have an audio frequency that is outside of a typical perceptible frequency range of human hearing.

Another example includes a method for locating a source of an audio emergency beacon having an audio frequency that is outside of a typical perceptible frequency range of human hearing. The method includes facilitating receipt of the audio emergency beacon via an acoustic input device. The method also includes monitoring an amplitude of the audio emergency beacon. The method further includes providing an indication of a proximity to the source of the audio emergency beacon based on the amplitude of the audio emergency beacon.

Another example includes an emergency search system. The system includes at least one wireless electronic device. The at least one wireless electronic device includes an acoustic input device configured to receive an audio emergency beacon via an acoustic input device of a wireless electronic device. The audio emergency beacon can be emitted from a source wireless electronic device and having an audio frequency that is outside of a typical perceptible frequency range of human hearing. The at least one wireless electronic device also includes a processor configured to monitor an amplitude of the audio emergency beacon. The at least one wireless electronic device a display configured to provide an indication of a proximity to the source of the audio emergency beacon based on the amplitude of the audio emergency beacon.

### BRIEF DESCRIPTION OF THE DRAWINGS

FIG. 1 illustrates an example of a wireless electronic device.

FIG. 2 illustrates an example diagram of a search for a wireless electronic device emitting an audio emergency beacon.

FIG. 3 illustrates another example diagram of a search for a wireless electronic device emitting an audio emergency beacon.

FIG. 4 illustrates an example of a method for initiating an audio emergency beacon.

FIG. 5 illustrates an example of a method for locating a source of an audio emergency beacon.

### DETAILED DESCRIPTION

This disclosure relates to an audio emergency beacon. The audio emergency beacon can have an audio frequency that is outside of a typical perceptible frequency range of human hearing, such that the audio emergency beacon can be imperceptible to typical human hearing. As an example, the emergency audio beacon can have a frequency that is between approximately 19 kHz and approximately 20 kHz. The emergency audio beacon can be emitted by a wireless electronic device, such as a smart-phone, in response to contacting emergency services. For example, a wireless electronic device can include an application software program (i.e., an “App”) that is programmed to automatically emit the audio emergency beacon in response to a user contacting a Public Safety Answering Point (PSAP), such as by calling “911”. Therefore, the audio emergency beacon can allow emergency responders to find the wireless electronic device, and thus the user that may be in peril (e.g., when the user may not be able to assist in being found). Because the audio emergency beacon can be imperceptible to human hearing, the audio emergency beacon would not interfere with the phone call to the PSAP, and can enable the user to be found when the user needs to remain silent to avoid imminent danger.

Emergency service responders that are dispatched to an emergency scene can thus search for the wireless electronic device, and thus the user that may be in peril. As an example, the emergency service responders can carry wireless electronic devices that can be configured to receive the audio emergency beacon via an acoustic input device and can be programmed to detect the audio emergency beacon via a processor. For example, the wireless electronic devices can be configured to detect the audio emergency beacon by performing a Fast Fourier Transform on a range of input frequencies to detect the audio emergency beacon. The wireless electronic devices can thus monitor an amplitude of the audio emergency beacon to determine a relative proximity of the wireless electronic device to the source of the audio emergency beacon. As another example, multiple wireless electronic devices can be in wireless communication with each, and can communicate relative amplitudes of the audio emergency beacon with each other. Therefore, in a search that implements multiple searching wireless electronic devices, a given one of the wireless electronic devices can provide a directional indication to the source wireless electronic device based on a triangulation of the source of the audio emergency beacon in response to the monitored amplitude of the audio emergency beacon and the amplitudes of the audio emergency beacon received by other searching wireless electronic devices.

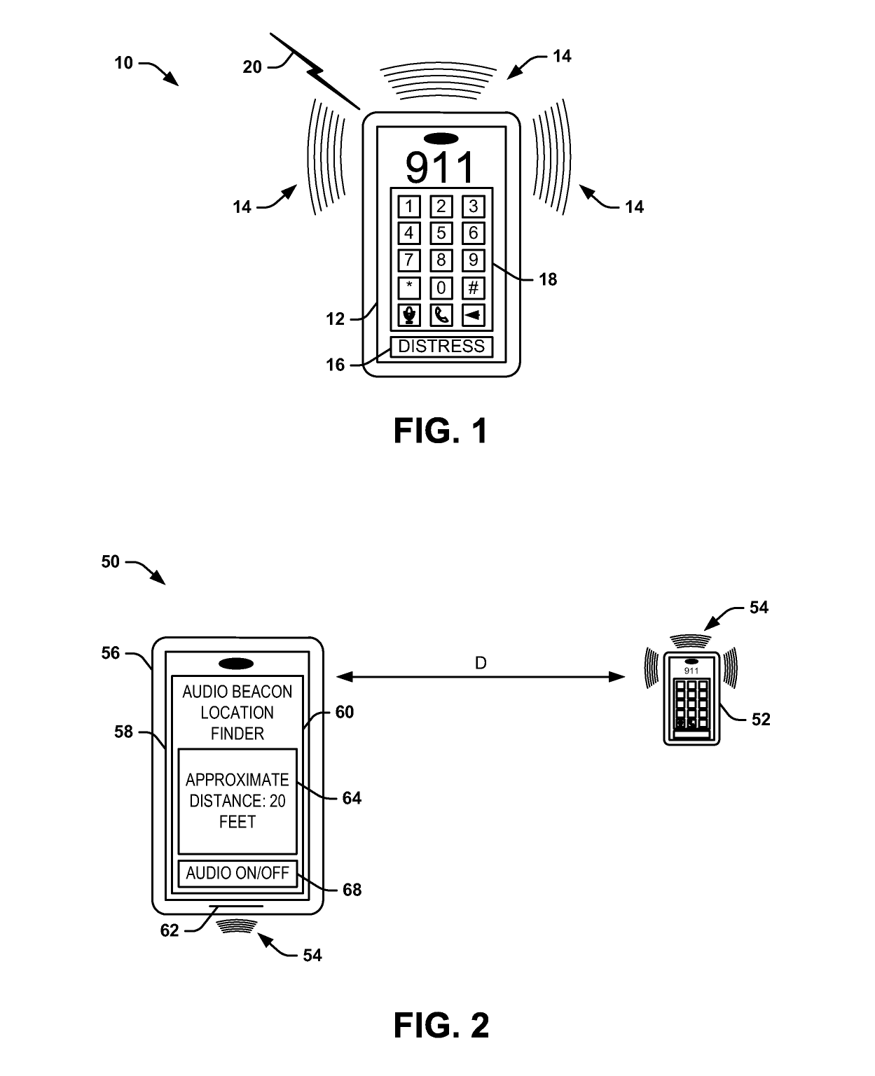

FIG. 1 illustrates an example of a wireless electronic device 10. The wireless electronic device 10 can correspond to a consumer electronic wireless communication product, such as a mobile phone, a smart-phone, or a tablet computer. Thus, the wireless electronic device 10 can be configured to send and receive phone calls via a network (e.g., the cellular network and/or Wi-Fi or Bluetooth) and can include network access. The wireless electronic device 10 includes at least one acoustic output device 12 (e.g., an audio speaker) that can provide audio communications to a user, such as received voice signals in a telephone call, or to play audio content (e.g., music or website content). As described herein, the acoustic output device(s) 12 can also emit an audio emergency beacon, demonstrated in the example of FIG. 1 at 14.

The wireless electronic device 10 can be programmed to emit the audio emergency beacon 14 at an audio frequency that is outside of a typical perceptible frequency range of human hearing, such that the audio emergency beacon can be objectively imperceptible to human hearing. As described herein, the phrase “outside of a typical perceptible frequency range of human hearing” can refer to an audio frequency that is inaudible to all or most people (e.g., based on a tendency of human hearing to degrade with age with respect to high audio frequencies). As an example, the emergency audio beacon 14 can have a monotonal frequency that is between approximately 19 kHz and approximately 20 kHz (e.g., at one or more of 19.1 kHz, 19.5 kHz, or 19.9 kHz). As another example, the audio frequency of the emergency audio beacon 14 can be a predetermined audio frequency that is within a perceptible frequency range of canines, such as an audio frequency that canines are trained to recognize and seek out.

The wireless electronic device 10 can be programmed to emit the audio emergency beacon 14 in response to inputs corresponding to a request for emergency services. While the emergency audio beacon 14 can be a monotonal audio signal, the emergency audio beacon 14 can also have an audio frequency that is based on the type of distress or can identify the wireless electronic device 10. As an example, the audio emergency beacon 14 can have an audio frequency that is at least one of a plurality of predetermined audio frequencies, such as programmed in the associated application program software. As another example, the audio emergency beacon 14 can be provided in a sequence of audio frequencies, such as encoded to identify the wireless electronic device 10 (e.g., to prevent spoofing and/or to distinguish the audio emergency beacon 14 from other sources of high-frequency audio noise).

In the example of FIG. 1, the wireless electronic device 10 includes a distress button 16 and a dialing keypad 18. As one example, the request for emergency services can be or can include the user pressing the distress button 16, such that the wireless electronic device 10 emits the audio emergency beacon 14 with or without an associated phone call using the dialing keypad 18. As another example, the wireless electronic device 10 can be programmed to emit the audio emergency beacon automatically in response to initiating a wireless phone call, indicated by a wireless signal 20, to a Public Safety Answering Point (PSAP), such as a “911” call.

Therefore, the audio emergency beacon 14 can be provided during and after the wireless phone call 20, and can be maintained until the user provides an input (e.g., via the distress button 16) to deactivate the audio emergency beacon 14. Thus, the emergency audio beacon 14 can be maintained even after cessation of the wireless phone call 20, such as to maintain the audio emergency beacon 14 after capture of the user and/or seizure of the wireless electronic device 10. Because the audio emergency beacon 14 can be imperceptible to human hearing, the audio emergency beacon would not interfere with the wireless phone call 20 to the PSAP, and can also enable the user to be found when the user needs to remain silent to avoid imminent danger. For example, if the wireless phone call 20 is in response to a break-in to the user's home, the audio emergency beacon 14 can be emitted without alerting the intruder. Additionally, the wireless electronic device 10 can be configured to provide no visual indication or only a hidden visual indication of the emission of the audio emergency beacon 14 to prevent knowledge of the emission of the audio emergency beacon 14 by a dangerous third party. Furthermore, as described in greater detail herein, the audio emergency beacon 14 can provide a means for the wireless electronic device 10, and thus the user of the wireless electronic device 10, to be found in a given geographic location.

In addition to the wireless signal 20 being associated with a wireless phone call to the PSAP, the wireless signal 20 can also be associated with other wireless signals, as well. As an example, the wireless signal 20 can communicate location information associated with the wireless electronic device 10. For example, the location information can correspond to location-based services associated with the wireless electronic device 10, such as global-positioning satellite (GPS) data, information corresponding to coupling to a wireless network (e.g., a Wi-Fi network), or registration to a specific base station in the cellular network. Therefore, the location information can be communicated via the wireless signal 20 to the PSAP (e.g., during the wireless phone call), and/or to emergency service responders to assist the emergency service responders in finding the wireless electronic device 10.

FIG. 2 illustrates an example diagram 50 of a search for a source wireless electronic device 52 emitting an audio emergency beacon, demonstrated at 54. The source wireless electronic device 52 can correspond to the wireless electronic device 10 in the example of FIG. 1. Therefore, reference is to be made to the example of FIG. 1 in the following description of the example of FIG. 2.

The diagram 50 demonstrates the source wireless electronic device 52 and a searcher wireless electronic device 56. The searcher wireless electronic device 56 can correspond to a consumer electronic wireless communication product, such as a mobile phone, a smart-phone, or a tablet computer, or can correspond to a dedicated emergency service communication device. The searcher wireless electronic device 56 includes a display screen 58 (e.g., a touchscreen) with which the user of the searcher wireless electronic device 56 can interact. In the example of FIG. 2, the searcher wireless electronic device 56 includes an audio beacon location finder 60 that can be displayed and operated via the display screen 58. As an example, the audio beacon location finder 60 can correspond to an application software program that is programmed to allow the searcher wireless electronic device 56 to detect the audio emergency beacon 54 emitted from the source wireless electronic device 52 and to determine an approximate location of the source wireless electronic device 52 based on the audio emergency beacon 54.

The searcher wireless electronic device 56 includes at least one acoustic input device 62 (e.g., a microphone) that is configured to receive the audio emergency beacon 54. As an example, the searcher wireless electronic device 56 can include a processor that is configured to detect the audio emergency beacon 54 via a Fast Fourier Transform (FFT) operation across the range of audio frequencies received via the acoustic input device(s) 62. The searcher wireless electronic device 56 can thus be programmed to monitor an amplitude of the audio emergency beacon 54 (e.g., via the processor) to determine an approximate proximity and/or direction of the source wireless electronic device 52 to the searcher wireless electronic device 56.

For example, the searcher wireless electronic device 56 can be programmed to be calibrated with respect to amplitude ranges of the audio emergency beacon 54, such that a given amplitude of the audio emergency beacon 54 can be identifiable as to the approximate proximity, demonstrated in the example of FIG. 2 as a distance D. In the example of FIG. 2, the audio beacon location finder 60 includes a distance monitor 64 that is displayed on the display screen 58 that indicates the approximate proximity D of the searcher wireless electronic device 56 to the source wireless electronic device 52. For example, the calibration of the distance monitor 64 can be provided a priori, such as during a calibration or setup phase of the audio beacon location finder 60. Additionally, the audio beacon location finder 60 includes an audio toggle 66 that can be activated and deactivated by the user of the searcher wireless electronic device 56 to provide an audial indication of the approximate proximity D to the source wireless electronic device 52. For example, the audio toggle 66 can be activated to provide a solid tone or a pulsed tone within the audio frequency range of human hearing that can change in pitch and/or frequency of pulses in response to changes to the approximate proximity D. Therefore, the audio toggle 66 can be activated to provide an audial indication of the approximate proximity D in addition to or as opposed to the visual indication provided by the distance monitor 64.

In addition, the user of the searcher wireless electronic device 56 can move in a given direction, and the searcher wireless electronic device 56 can determine a change in amplitude, and thus a corresponding change in the approximate proximity D. The searcher wireless electronic device 56 can thus indicate (e.g., via the distance monitor 64) to the user the relative approximate proximity D based on changes in position of the searcher wireless electronic device 56 in real-time. For example, the user can walk with the searcher wireless electronic device 56 in a given direction, such that the searcher wireless electronic device 56 can indicate whether the searcher wireless electronic device 56 is getting closer or farther from the source wireless electronic device 52 based on change in the amplitude of the audio emergency beacon 54. As another example, the user of the searcher wireless electronic device 56 can merely wave his/her hand with the searcher wireless electronic device 56 in it in a wide swath across the user's person, such that the searcher wireless electronic device 56 can provide indications of the changes in the approximate proximity D of the source wireless electronic device 52. Accordingly, the searcher wireless electronic device 56 can indicate an approximate direction to the source wireless electronic device 52 based on the monitored changes in amplitude of the audio emergency beacon 54.

Similar to as described previously, the source wireless electronic device 52 can be configured to provide location information via a wireless signal (e.g., the wireless signal 20). As an example, the location information can correspond to location-based services associated with the wireless electronic device 10, such as GPS data, information corresponding to coupling to a wireless network (e.g., a Wi-Fi network), or registration to a specific base station in the cellular network. The source wireless electronic device 52 can thus communicate the location information to the PSAP. Therefore, the PSAP can communicate the location information to the searcher wireless electronic device 56 to assist the user of the searcher wireless electronic device 56 to find the source wireless electronic device 52 using both the location information and the audio emergency beacon 54. For example, the location information can be implemented by the user of the searcher wireless electronic device 56 to determine an approximate location of the source wireless electronic device 52, such as to narrow the location down to within a building (e.g., based on coupling of the source wireless electronic device 52 to a wireless network within the building, or based on latitude/longitude). The user of the searcher wireless electronic device 56 can then implement the audio emergency beacon 54 to determine the location of the source wireless electronic device 52 within the building (e.g., on a specific floor or in a specific region).

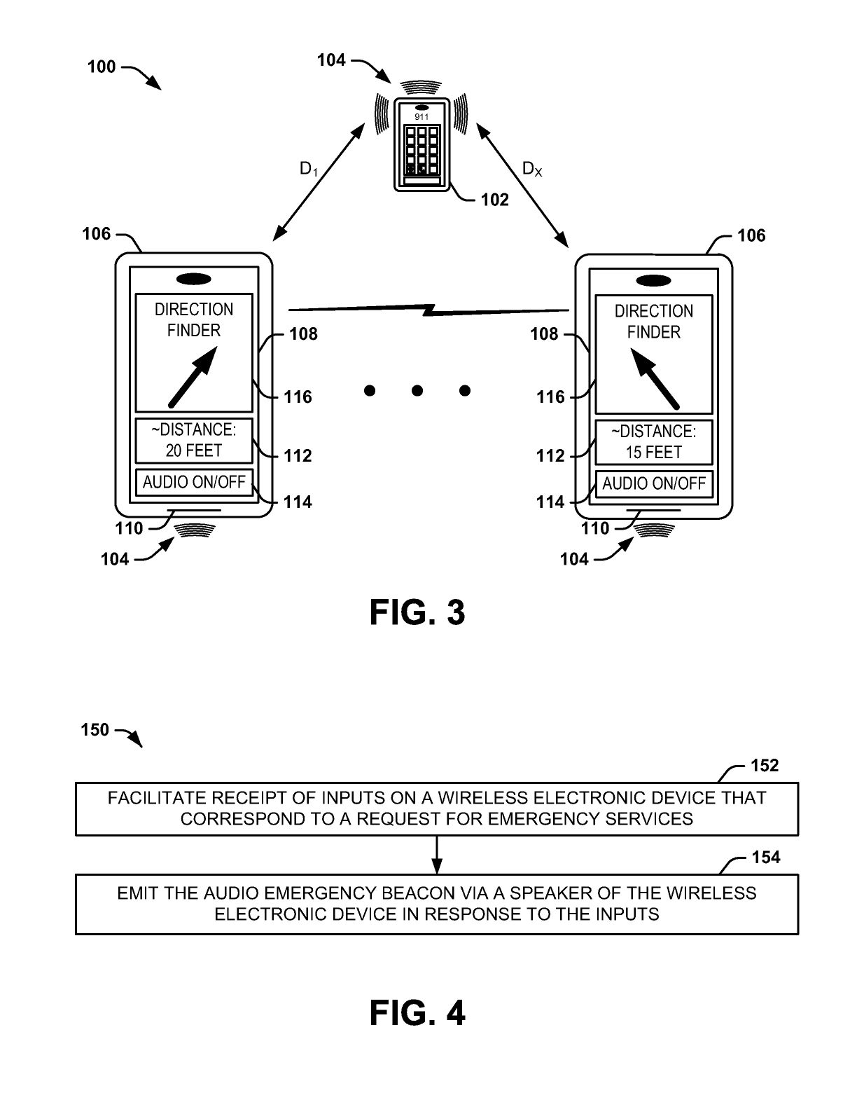

A search system that implements the searcher wireless electronic device 56 can implement a single searcher wireless electronic device 56, or a plurality of searcher wireless electronic devices 56, to determine the location of the source wireless electronic device 52, and thus the user of the source wireless electronic device 52 that may be in peril. FIG. 3 illustrates another example diagram 100 of a search for a source wireless electronic device 102 emitting an audio emergency beacon 104. The source wireless electronic device 102 can correspond to the wireless electronic device 10 in the example of FIG. 1. Therefore, reference is to be made to the example of FIG. 1 in the following description of the example of FIG. 3.

The diagram 100 demonstrates the source wireless electronic device 102 and a plurality of searcher wireless electronic devices 106. The searcher wireless electronic devices 106 can each correspond to a consumer electronic wireless communication product, such as a mobile phone, a smart-phone, or a tablet computer, or can correspond to a dedicated emergency service communication device. The searcher wireless electronic devices 106 can each correspond to the searcher wireless electronic device 56, and can thus include a display screen 108 (e.g., a touchscreen), on which an audio beacon location finder (e.g., the audio beacon location finder 60) can operate. Each of the searcher wireless electronic devices can also include at least one acoustic input device 110 that is configured to receive the audio emergency beacon 104, such that the respective searcher wireless electronic devices 106 can detect the audio emergency beacon 104 via an FFT operation across the range of audio frequencies received via the acoustic input device(s) 110. Therefore, similar to as described previously, the searcher wireless electronic devices 106 can each be programmed to monitor an amplitude of the audio emergency beacon 104 (e.g., via a processor) to determine an approximate proximity and/or direction of the source wireless electronic device 102 to the respective searcher wireless electronic devices 106.

For example, similar to as described previously, each of the searcher wireless electronic devices 106 can be programmed to be calibrated with respect to amplitude ranges of the audio emergency beacon 104, such that a given amplitude of the audio emergency beacon 104 can be identifiable as to the approximate proximity, demonstrated in the example of FIG. 3 as distances “D₁” through “Dₓ”, with respect to each of a quantity X searcher wireless electronic devices 106, where X is a positive integer. In the example of FIG. 3, each of the searcher wireless electronic devices 106 can display a distance monitor 112 on the display screen 108 to indicate the respective approximate proximity of the respective searcher wireless electronic device 106 to the source wireless electronic device 102. Additionally, each of the searcher wireless electronic devices 106 can include an audio toggle 114 that can be activated and deactivated by the user of the searcher wireless electronic device 106 to provide an audial indication of the respective approximate proximity to the source wireless electronic device 102.

In addition, the searcher wireless electronic devices 106 can be configured to cooperate to determine respective directions of the source wireless electronic device 102 with respect to each of the respective searcher wireless electronic devices 106. In the example of FIG. 3, each of the searcher wireless electronic devices 106 includes a direction finder 116 that is configured to provide a visual indication of the direction of the source wireless electronic device 102 with respect to the given location of the respective searcher wireless electronic device 106 in real-time. For example, during a search effort, each of the searcher wireless electronic devices 106 can be configured to monitor the amplitude of the audio emergency beacon 104, and can transmit the respective monitored amplitude of the audio emergency beacon 104 to each other searcher wireless electronic device 106 in the search effort, along with corresponding respective location information. As one example, the location information and the monitored amplitude of the audio emergency beacon 104 can be transmitted as separate information, or could be aggregated such that a given one of the searcher wireless electronic devices 106 transmits an approximate proximity of the respective searcher wireless electronic device 106 to the source wireless electronic device 102. Therefore, each of the searcher wireless electronic devices 106 can receive the location information and the monitored amplitude of the audio emergency beacon 104 from each of the other searcher wireless electronic devices 106 to triangulate a position of the source wireless electronic device 102 based also on the amplitude of the audio emergency beacon 104 that is monitored at the respective one of the searcher wireless electronic devices 106. Accordingly, the direction finder 166 can provide the visual indication of the direction of the source wireless electronic device 102, and the distance monitor 112 can provide a more accurate indication of the approximate proximity to the source wireless electronic device 102, based on the collaborative triangulation of the location of the source wireless electronic device 102 via the searcher wireless electronic devices 106. As a result, the users of the searcher wireless electronic devices 106 can more quickly and easily determine the location of the source wireless electronic device 102, and thus the user that may be in peril, based on the audio emergency beacon 104.

Certain embodiments of the invention are disclosed herein with reference to flowchart illustrations of methods, systems, and computer program products. It can be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in a non-transitory computer-readable medium that can direct a computer or other programmable data processing apparatus (e.g., one or more processing cores) to function in a particular manner, such that the instructions stored in the computer-readable medium result in an article of manufacture including instructions which implement the function specified in the flowchart block or blocks. The computer program instructions may also be loaded onto a computer (e.g., a desktop computer, a smart phone, a tablet computer, etc.) or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks or the associated description.

FIG. 4 illustrates an example of a method 150 for initiating an audio emergency beacon (e.g., the audio emergency beacon 14). At 152, inputs (e.g., dialing inputs provided to contact a PSAP) are facilitated to be received on a wireless electronic device (e.g., via the dialing keypad 18 on the wireless electronic device 10) that correspond to a request for emergency services (e.g., a “911” call). At 154, the audio emergency beacon is emitted via an acoustic output device (e.g., the acoustic output device(s) 12) of the wireless electronic device in response to the inputs. The audio emergency beacon can have an audio frequency that is outside of a typical perceptible frequency range of human hearing (e.g., between approximately 19 kHz and approximately 20 kHz).

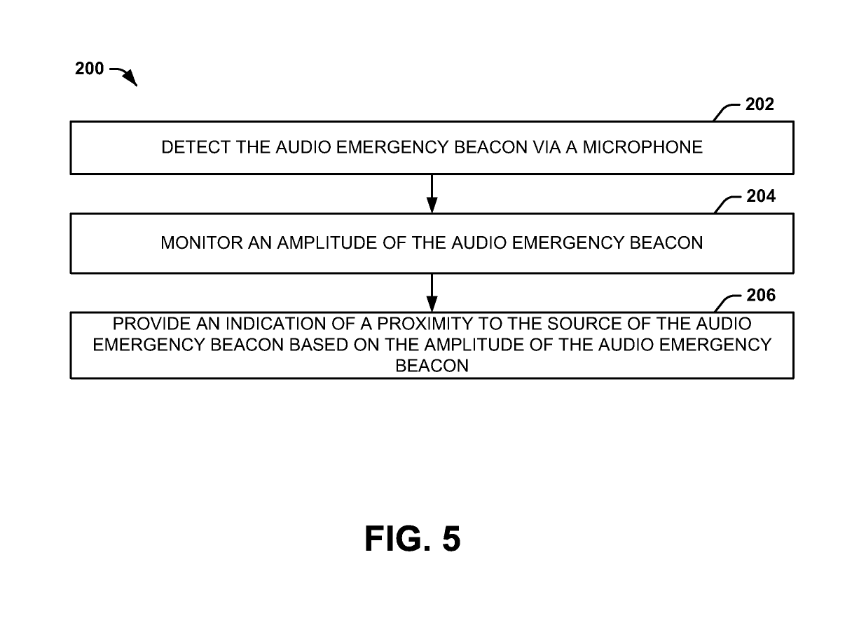

FIG. 5 illustrates another example of a method 200 for locating a source of an audio emergency beacon (e.g., the audio emergency beacon 14 emitted from the source wireless electronic device 52) having an audio frequency that is outside of a typical perceptible frequency range of human hearing (e.g., between approximately 19 kHz and approximately 20 kHz). At 202, the audio emergency beacon is facilitated to be received via an acoustic input device (e.g., the acoustic input device(s) 62 of the searcher wireless electronic device 56). At 204, an amplitude of the audio emergency beacon is monitored (e.g., via a processor). At 206, an indication of a proximity to the source of the audio emergency beacon is provided based on the amplitude of the audio emergency beacon (e.g., via the distance monitor 64).

What is disclosed herein are examples. It is, of course, not possible to describe every conceivable combination of components or methods, but one of ordinary skill in the art can recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A computer readable medium that, when executed, is configured to implement a method for initiating an audio emergency beacon, the method comprising:
facilitating the receipt of inputs on a wireless electronic device that correspond to a request for emergency services; and
emitting the audio emergency beacon via an acoustic output device of the wireless electronic device in response to the inputs, the audio emergency beacon having an audio frequency that is outside of a typical perceptible frequency range of human hearing.

2. The medium of claim 1, wherein receiving inputs on the wireless electronic device comprises receiving phone dialing inputs for a phone call to a Public Safety Answering Point (PSAP), and wherein emitting the audio emergency beacon comprises emitting the audio emergency beacon via the acoustic output device of the wireless electronic device in response to receiving the phone dialing inputs for the phone call to the PSAP.

3. The medium of claim 2, further comprising maintaining the audio emergency beacon after cessation of the phone call to the PSAP until receipt of a dedicated cessation input.

4. The medium of claim 1, wherein emitting the audio emergency beacon comprises emitting the audio emergency beacon at at least one of a plurality of predetermined frequencies that are outside of the typical perceptible frequency range of human hearing.

5. The medium of claim 1, wherein emitting the audio emergency beacon comprises emitting the audio emergency beacon at a plurality of predetermined frequencies that are outside of the typical perceptible frequency range of human hearing in a predetermined sequence code that is associated with an identity of the wireless electronic device.

6. The medium of claim 1, further comprising transmitting a physical location of the wireless electronic device via location-based services associated with the wireless electronic device in response to receiving the inputs.

7. The medium of claim 1, wherein the audio frequency of the audio emergency beacon is between approximately 19 kHz and approximately 20 kHz.

8. The medium of claim 1, wherein the wireless electronic device is configured as one of a smart-phone and a tablet computer operating an application software program that is programmed to emit the audio emergency beacon via the acoustic output device in response to the inputs to contact the emergency services.

9. The medium of claim 1, wherein receiving the inputs on the wireless electronic device comprises receiving a dedicated input to request search for the wireless electronic device by emergency services, and wherein emitting the audio emergency beacon comprises emitting the audio emergency beacon in response to the dedicated input corresponding to activation of the audio emergency beacon.

10. A computer readable medium that, when executed, is configured to implement method for locating a source of an audio emergency beacon having an audio frequency that is outside of a typical perceptible frequency range of human hearing, the method comprising:
detecting the audio emergency beacon via an acoustic input device;
monitoring an amplitude of the audio emergency beacon; and
providing an indication of a proximity to the source of the audio emergency beacon based on the amplitude of the audio emergency beacon.

11. The medium of claim 10, wherein detecting the audio emergency beacon comprises performing a Fast Fourier Transform on a range of audio frequencies received via the acoustic input device.

12. The medium of claim 10, wherein facilitating receipt of the audio emergency beacon comprises facilitating receipt of the audio emergency beacon via the acoustic input device associated with a first wireless electronic device, and wherein monitoring the amplitude of the audio emergency beacon comprises monitoring the amplitude of the audio emergency beacon via the first wireless electronic device, and wherein providing the indication comprises providing the indication of the proximity to the source of the audio emergency beacon with respect to the first wireless electronic device.

13. The medium of claim 12, further comprising:
facilitating receipt of the monitored amplitude of the audio emergency beacon and location information associated a second wireless electronic device; and
providing an indication of a direction to the source of the audio emergency beacon at the first wireless electronic device based on the monitored and received amplitudes of the audio emergency beacon and the location information associated the second wireless electronic device.

14. The medium of claim 10, further comprising:
facilitating receipt of location-based services data corresponding to a physical location of a wireless electronic device corresponding to the source of the audio emergency beacon transmitted from one of the wireless electronic device and a Public Safety Answering Point (PSAP); and
determining an approximate location of the wireless electronic device based on the location-based services data.

15. The medium of claim 10, wherein providing the indication of the proximity to the source of the audio emergency beacon comprises providing an audial indication of the proximity to the source of the audio emergency beacon based on the amplitude of the audio emergency beacon.

16. An emergency search system comprising at least one wireless electronic device, the at least one wireless electronic device comprising:
an acoustic input device configured to receive an audio emergency beacon via an acoustic input device of a wireless electronic device, the audio emergency beacon being emitted from a source wireless electronic device and having an audio frequency that is outside of a typical perceptible frequency range of human hearing;
a processor configured to monitor an amplitude of the audio emergency beacon; and
a display configured to provide an indication of a proximity to the source of the audio emergency beacon based on the amplitude of the audio emergency beacon.

17. The system of claim 16, wherein the processor is configured to perform a Fast Fourier Transform on a range of audio frequencies received via the acoustic input device to detect the audio emergency beacon.

18. The system of claim 16, wherein the system comprises a plurality of wireless electronic devices each comprising an antenna configured to transmit and receive the monitored amplitude of the audio emergency beacon and location information between each other, wherein the display is configured to provide an indication of a direction to the source of the audio emergency beacon based on the monitored and received amplitudes of the audio emergency beacon.

19. The system of claim 16, further comprising an antenna configured to receive location-based services data corresponding to a physical location of the source wireless electronic device transmitted from one of the source wireless electronic device and a Public Safety Answering Point (PSAP), wherein the processor is further configured to calculate an approximate location of the source wireless electronic device based on the location-based services data.

20. The method of claim 16, wherein the display is further configured to provide an audial indication of the proximity to the source of the audio emergency beacon based on the amplitude of the audio emergency beacon.
